(19) United States
(12) Patent Application Publication
(10) Pub. No.: US 2007/0057143 A1
(43) Pub. Date: Mar. 15, 2007

(54) Nail Impression Molding Kit

(76) Inventors: Scott L Nielson, Layton, UT (US); Craig P Gifford, West Jordan, UT (US)

Correspondence Address: SCOTT NIELSON, 1076 WALBURK AVE, LAYTON, UT, 84040, US

(21) Appl. No.: 11/162,437

(22) Filed: Sep. 9, 2005

(51) Int. Cl. B28B 7/26

(52) U.S. Cl. 249/120

(57) ABSTRACT

A kit is assembled for the use in easily preparing mold impressions of a natural nail surface. The kit includes a master tray, which may include markings by number or illustration indicating a relationship between the desired mold results and related nail surfaces, i.e., fingers or toes. The kit optionally includes individual nail enclosures, which may fit inside the master tray, making it easy to take accurate and predictable impressions of each desired natural nail surface. The kit also includes mold impression material which maintains dimensional stability and accurately reflects the desired nail surface object. Further, a dispenser is included in the kit to allow for dispensing the impression material into the optional nail enclosures and upon the nail surface. The result of this kit is the easy collection of desired impression mold of natural nail surfaces. While the invention has many applications, it is anticipated that this kit will make it easy to acquire impressions of natural finger and toe nail surfaces.

### FIELD OF THE INVENTION

The present invention relates to custom fit artificial nails and, more specifically, to a kit of molding materials permitting a natural nail surface to be cast in an individual mold.

### BACKGROUND AND RELATED ART

Artificial nails (fingernails and toenails) typically comprise thin, elongated, plastic structures having a configuration substantially similar to a real fingernail. Through use of an adhesive, the artificial fingernails can be selectively secured to existing fingernails. One of the benefits of artificial nails is that they enable a user to selectively have uniform nails of a desired thickness, length, and configuration without having to wait for the real nails to grow. This is especially useful to those who have weak nails that easily crack or break.

One method of applying artificial nails used in nail salons involves a time-consuming and laborious process of applying an acrylic to each natural nail surface. After the application of the acrylic the artificial nail is shaped by a nail technician. The above process requires one skilled in application of acrylic and the results are generally improved with experience. Another method involves the application of prefabricated nails. These prefabricated nails are painstakingly shaped to fit the cuticle end of the natural nail surface. The problem with this approach is that each nail surface has its own unique curvature and arch that a prefabricated artificial nail simply cannot anticipate. Additionally, the prefabricated nails are made from materials that are not reusable thus requiring the process of shaping to be repeated each time a desire for artificial nails is presented.

The solution to the current problems in the field of artificial nails is to create a customized artificial nail product composed of material that allows the customized product to be reused. This solution is presented by U.S. Pat. No. 5,968,302 and U.S. Pat. No. 6,196,234. These patents are directed to precision fit nails and methods for manufacturing precision fit nails. The precision fit nails described in these patents address many of the problems described above because they are made using models of real nails to cast acetone resistant thermoplastic artificial nails with a bottom surface that closely matches the top surface of the corresponding real nails. However, the processes of measuring for and manufacturing precision fit nails in accordance with U.S. Pat. No. 5,968,302 and U.S. Pat. No. 6,196,234 are somewhat complex and generally require a substantial amount of labor.

U.S. Pat. No. 5,228,164 is aimed at providing a kit for the creation of customized molds of a human foot. This patent presents interesting possibilities regarding the kit of creating custom molds by using traditional fabric concepts. The approach of this patent would not work in creating the type of accuracy required in creating usable nail surface molds. As in other prior art, the kit contemplated by this patent requires specialized skills for desired results.

U.S. Pat. No. 6,177,034 provides methods for creating customized three dimensional prosthetic surfaces from mold impressions. The approach in this patent requires that a positive mold impression is created after the original mold impression has been created. This positive mold impression is then digitized and customized prosthetic details are then added to the positive 3D scan. The process of this patent is needlessly time consuming, wasteful of resources and complicated. The application of this patent is more applicable to appendages like fingers and toes at best, so it is improbable that reliable results of molding natural nail surface could be achieved with the approach described in this prior art.

U.S. Pat. No. 6,463,351 is directed towards providing artificial limbs through the use of molds and scanning those molds to create a customized medical prosthetic device. A serious drawback in this patent is the requirement for physicians or experts in the field of prosthetics to be involved in creating the mold. Just like other prior art, this patent involves a laborious process demanding sophisticated skills and experience to successfully create the desired mold.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 is a drawing showing the kit contents.

### DETAILED DESCRIPTION OF THE PREFERRED EMBODIMENTS

The present invention is directed to simplifying the process of taking impression molds of a natural nail surface by including in a kit all the materials that a consumer (lay person) would need to successfully achieve a desired result. Once the molds have been completed and returned to the manufacturing facility, the impression molds can then be imaged, creating a three dimensional surface permitting the creation of a customized reusable artificial nail product for the consumer. In the description that follows, tasks may be described in a sequence that has been selected to facilitate an understanding of the disclosed embodiments of the invention. It should be clear, however, that in practicing the invention, many tasks may be performed in an arbitrary order, and therefore any particular order implied by the description usually represents one of many possibilities.

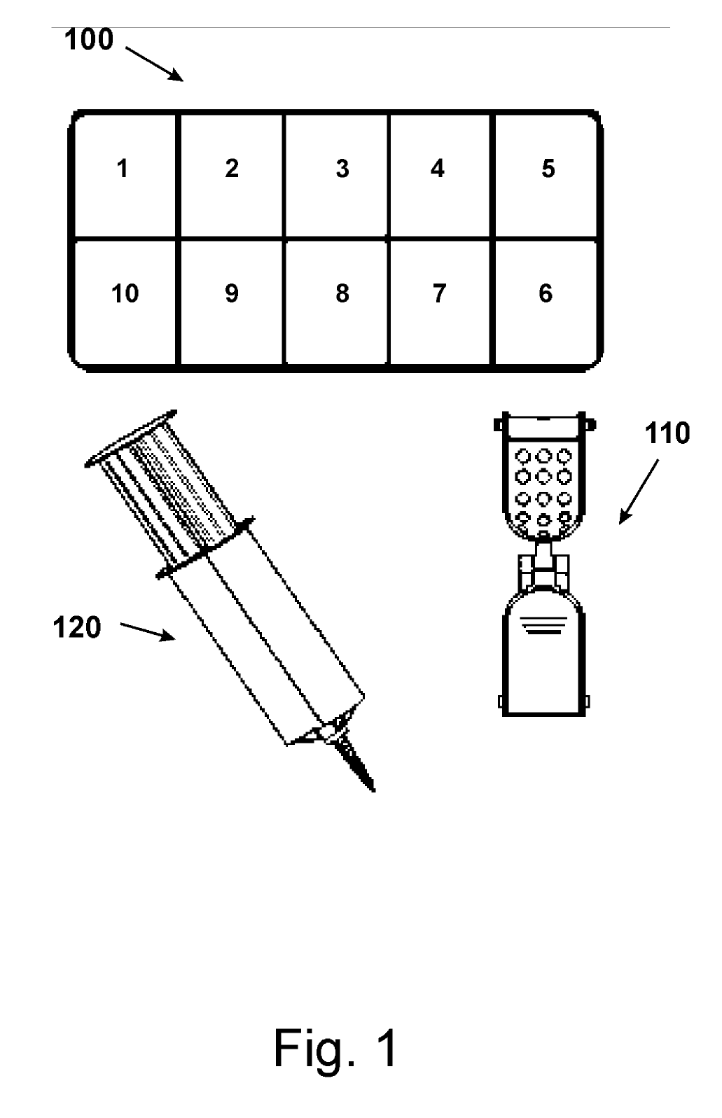

FIG. 1 shows the contents of a kit for the use in easily preparing mold impressions of a natural nail surface. The kit includes a master tray 100, which may include markings by number or illustration indicating a relationship between the desired mold results and related nail surfaces, i.e., fingers or toes. The kit optionally includes individual nail mold enclosures 110, which may fit inside the master tray 100, making it easy to take accurate and predictable impressions of each desired natural nail surface. The kit also includes mold impression material which maintains dimensional stability and accurately reflects the desired nail surface object. Further, a dispenser 120 is included in the kit to allow for dispensing the impression material into the optional nail mold enclosures 110 and upon the nail surface.

The kit is used by taking the dispenser 120 and infusing enough mold impression material into the individual nail mold enclosure 110 or distributing enough material directly upon the natural nail surface. Once the impression process is started the consumer waits until the molding material has cured, then the consumer takes the individual nail mold enclosure 110 or the cured material on their natural nail surface and places the mold inside the master tray 100 in its corresponding reference to the nail surface just molded.

The result of this kit is the easy collection of desired impression molds of natural nail surfaces. These impressions can be taken by the average consumer and the results are usable in generating a customized artificial nail product for the individualized consumer.

The present invention overcomes prior art as described above in simplifying the process of taking impression molds of a natural nail surface. There is no requirement for specialized knowledge or skill in preparing the molds as the kit presents a simplified approach through the individualized nail mold enclosures 110, the master tray 100 and the dispenser 120. The laborious and time consuming tasks presented by the prior art are overcome by providing the consumer with an easy to understand kit inclusive of all the basic materials needed to create the desired impression mold of the desired nail surface. The present invention presents a real and recognizable time savings over the prior art.

Specifically, U.S. Pat. No. 6,177,034 presents a wasteful approach of imaging a positive after the negative mold has been created. The present invention eliminates this step entirely and demonstrates that accurate results may be achieved by using proper molding material and the specialized components as described in the kit.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A kit for preparing mold impressions of natural nail surfaces comprising:
a master tray used to sort the individual nail molds, optional individual nail mold enclosures, mold impression material, and a dispenser.

2. A kit according to claim 1, wherein said master tray as provided may contain as few as one and as many as approximately twenty individualized compartments.

3. A kit according to claim 2, wherein said master tray permits individual nail surface impression molds to be easily sorted and tracked.

4. A kit according to claim 2, wherein said master tray may be used instead of the optional nail mold enclosures to accept the desired impression mold of the natural nail surface.

5. A kit according to claim 1, wherein said optional individual nail mold enclosures may be of various sizes permitting a fit around a variety of natural nail surfaces.

6. A kit according to claim, wherein natural nail surfaces include fingernails and toenails.

7. A kit according to claim, wherein various size mold enclosures are large enough to fit over any natural nail surface.

8. A kit according to claim, wherein said optional individual nail mold enclosures will permit adequate mold impression material to be infused to achieve the goal of creating a mold of the natural nail surface.

9. A kit according to claim 1, wherein mold impression material may be any molding material which maintains dimensional stability after removal from the natural nail surface object.

10. A kit according to claim 1, wherein mold impression material may not require a rigid tray enclosure to hold the mold impression material preventing it from distorting the natural nail surface object.

11. A kit according to claim 10, wherein the mold impression material may be placed directly into the master tray.

12. A kit according to claim 1, wherein mold impression material may include sodium alginates, thermoplastic molding resins, silicones, reversible hydro colloids, poly ethers and vinyl polysiloxane.

13. A kit according to claim 1, wherein the dispenser may permit the molding material to be infused into the optional mold enclosures.

14. A kit according to claim 1, wherein the dispenser may permit the molding material to be distributed over the desired natural nail surface object.

15. A kit according to claim 1, wherein the dispenser may prevent the molding material from prematurely setting up before the desired nail surface object can be molded.

16. A kit according to claim 1, wherein the dispenser may provide a mixing solution for the mold impression material to be mixed as it is infused into the optional mold enclosures.
